(19) United States
(12) Patent Application Publication
(10) Pub. No.: US 2019/0014326 A1
(43) Pub. Date: Jan. 10, 2019

(54) IMU ENHANCED REFERENCE LIST MANAGEMENT AND ENCODING

(71) Applicant: Intel Corporation, Santa Clara, CA (US)

(72) Inventors: Jason Tanner, Folsom, CA (US); Paul S. Diefenbaugh, Portland, OR (US)

(73) Assignee: Intel Corporation, Santa Clara, CA (US)

(21) Appl. No.: 15/642,773

(22) Filed: Jul. 6, 2017

(51) Int. Cl. H04N 19/162; H04N 19/124; H04N 19/139; H04N 19/196; H04N 19/172

(52) U.S. Cl. CPC H04N 19/162; H04N 19/124; H04N 19/577; H04N 19/196; H04N 19/172; H04N 19/139

(57) ABSTRACT

A method for an IMU enhanced reference list management and encoding is described herein. The method includes obtaining a plurality of reference frames and updating the plurality of reference frames based on a position information and a motion information of a user. The method also includes encoding a current frame of a scene based on the plurality of reference frames and a spatial location of the current frame and transmitting the current frame after encoding to be rendered.

### BACKGROUND ART

Video streams may be encoded in order to reduce the image redundancy contained in the video streams. An encoder may compress frames of the video streams so that more information can be sent over a given bandwidth or saved in a given file size. The compressed frames may be transmitted to a receiver or video decoder that may decode or decompress the frame for rendering on a display. In some cases, the compressed frames are sent to a virtual reality display. The virtual reality display may be a head mounted display (HMD), and can track the head of a user. The HMD may position a display near the eyes of a user.

### BRIEF DESCRIPTION OF THE DRAWINGS

FIG. 1 is a block diagram of a plurality of reference frames stored based on a spatial location around the viewer;

FIGS. 2A, 2B, and 2C illustrate reference frames used for encoding based on the position or motion of a user;

FIGS. 3A and 3B illustrate a frame 300A and a frame 300B encoded via position and motion information;

FIG. 4 is a process flow diagram of a method for an IMU enhanced reference list management and encoding

FIG. 5 is a block diagram of an exemplary system that enables IMU enhanced reference list management and encoding; and

FIG. 6 is a block diagram showing a medium that contains logic for an IMU enhanced reference list management and encoding.

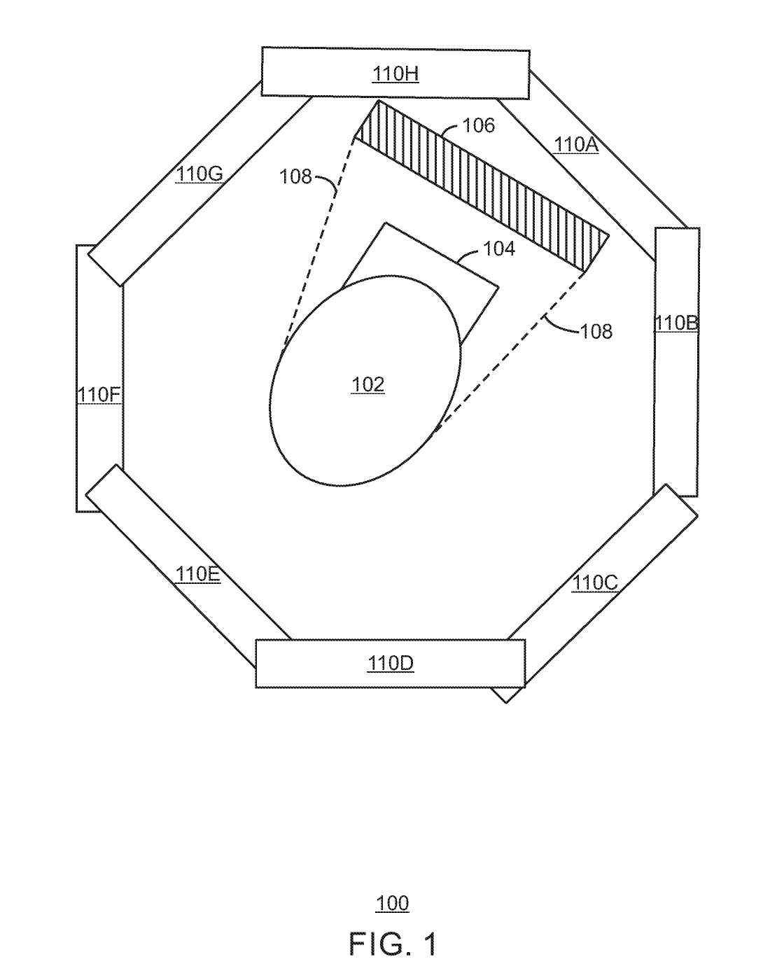

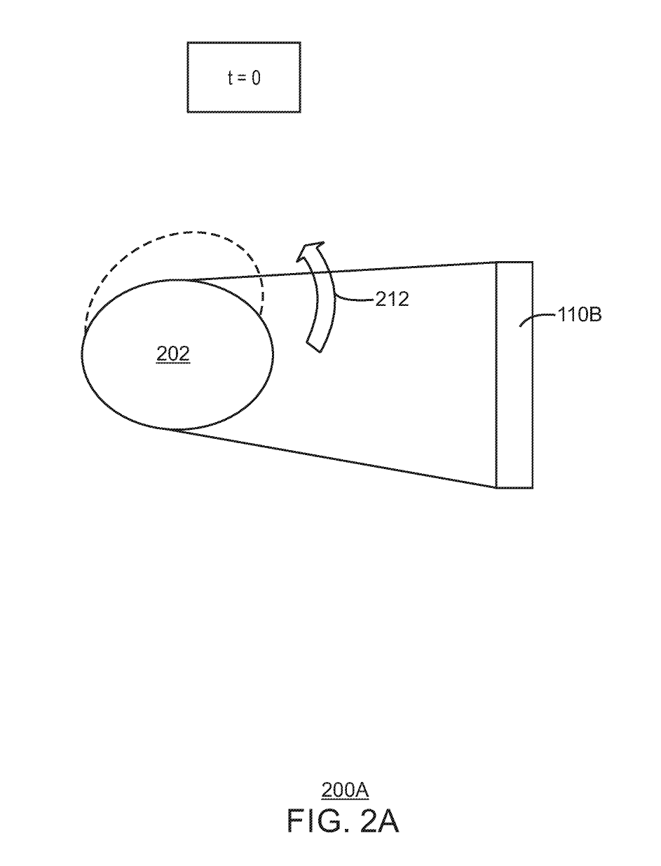

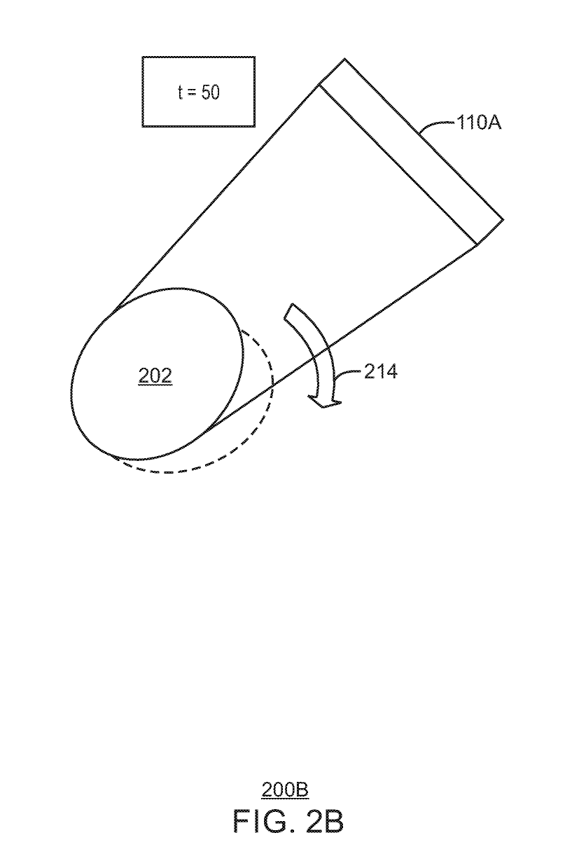

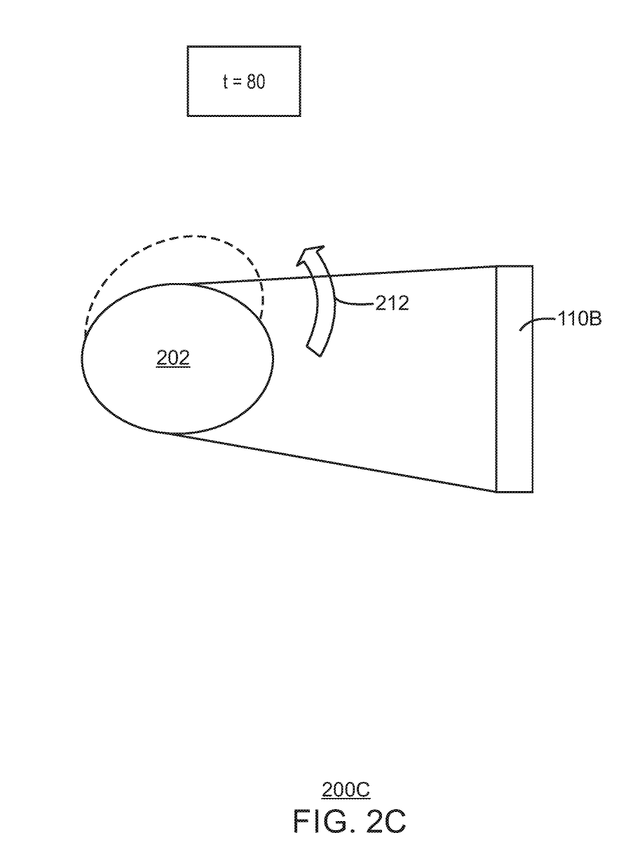

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

A virtual reality system may include frames known as reference frames. As used herein, reference frames are frames from a video stream that are fully specified. These fully specified frames may be used to predict other frames of the video stream. In the context of virtual reality, the reference frames may be used to predict or specify other frames of the environment based on the movement of the user. The reference frames may be stored as a list, and updated.

Embodiments described herein enable an inertial measurement unit (IMU) enhanced reference list management and encoding. In embodiments, the IMU enhanced reference list and encoding may be used in wireless encoding. A plurality of reference frames may be obtained and the plurality of reference frames may be updated based on a position and a motion information of a user. Frames of a scene may be encoded based on the reference frames and the position and motion information. Additionally, the encoded frames may be wirelessly transmitted to another device to be rendered. In embodiments, the device may be a virtual reality display, including but not limited to an HMD. The virtual reality display may send location/positional information to a host system including an encoder. The IMU data can be used to manage the list of reference pictures or frames. The IMU data may also be used to apply a selective quantization at the encoder on the host system. Additionally, the IMU data may be used to enable/refine error recovery on the sink/decoder.

The present techniques improve the visual quality for wireless virtual reality (VR). When users are wearing a head mounted display (HMD) the head motion changes the scene being viewed. That motion is transferred back to the host system to change render. The present techniques enable video encoding for wireless VR based on using that motion. Further, the present techniques use the positional tracking system from the HMD to be associated with the reference frames. Reference frames will be selected based on their positional coordinates to be maintained in the reference picture list. The future frames will select which frame to be referenced based on the physical, spatial location of the particular future frame. For example, as a user moves their head to reveal more of the scene that was not shown in the prior frame, the encoder will select a past frame that does contain that portion of the scene. Since the reference list optimizes the frames stored based on their physical location, one of the reference frames will contain that region (unless that region has never been seen before). This both saves bandwidth, resulting in better compression, as well as improved performance. In addition, the quantization parameter (QP) will be modified to give more or less compression depending on the movement from the HMD. The portion of the frame that will likely be omitted in subsequent frames will have a higher QP to save bandwidth for the rest of the frame. This results in a more efficient optimization of bits.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a plurality of reference frames stored based on a spatial location around the viewer. For ease of description, the reference frames are illustrated as being finite in number and as lying within a single plane. However, any number of reference frames may be used. Moreover, the reference frames may lie at any point around the user. For example, the reference frames may occur at any point on a sphere surrounding the user. The reference frames may be used to predict other frames as described below.

For example, the frames may be specified during compression using intra-coded frames (I-frames), predicted picture frames (P-frames) and bi-directional predicted picture frames (B-frames). As used herein, specified refers to the data that is saved for each frame during compression. An I-frame is fully specified. In embodiments, a reference frame is an I-frame that is fully specified. A P-frame is specified by saving the changes that occur in each frame when compared to the previous frame, while a B-frame is specified by saving the changes that occur in each frame when compared to both the previous frame and the following frame. Thus, P- and B-frames have dependencies on other frames.

In the example of FIG. 1, a user 102 is illustrated wearing a wireless HMD 104 that includes at least one IMU. While the present techniques are described using an HMD, other virtual reality display units can be used. For example, the virtual reality scenes can be projected onto the retina of the user 102. The HMD 104 may also include a display that is used to render a frame 106 near the eyes of the user 102. As illustrated, either a reference frame 110H or a reference frame 110A can be used to render a frame 106 as part of a virtual reality scene displayed by the HMD 104. In FIG. 1, the user 102 is viewing a rendered scene including frame 106 displayed via the HMD 104. The dashed lines 108 represent the user's 102 field of view. The blocks 110A, 110B, 110C, 110D, 110E, 110F, 110G, and 110H represent reference frames that are stored based on position and motion information associated with each frame.

In some cases, the HMD 104 may include an IMU, a gyrometer, accelerometer, compass, or any combination thereof that can be used to derive position and motion information. The position information may be stored in terms of coordinates that enable a position of the frame to be described by a set of numbers. For example, the HMD may express position in a Cartesian coordinate system. The motion information refers to the change in position. The motion may be expressed in terms of a rate of change in position. Thus, the motion may be described in terms of displacement, distance, velocity, acceleration, time and speed, or any combination thereof.

The position and motion information may be obtained at the HMD 104 and transmitted to the host system. The host system may encode and transmit the scene including frame 106 based on the position and motion indicated by the HMD 104. In particular, IMU data may be used to determine which reference frames to use for encoding the scene. The current frame may be encoded via a macroblock referencing a reference frame of the plurality of reference frames that is spatially the closest, relative to the user position to the macroblock. In other words, the reference frame with the closest corresponding macroblock may be used to encode the macroblock of the current frame. The HMD 104 receives the encoded scene from the host system and decodes the scene, and then renders the scene to the user via the HMD 104. Thus, the scene may be rendered based on, at least in part, IMU motion tracking.

A plurality of reference frames 110 can be stored at the host system or the HMD for reference in the encode and decode processes. The number of reference frames may be based on the encoder/decoder specifications. For example, a maximum number of concurrent reference frames supported by the H.264 Standard is 16. In other examples, the maximum number of reference frames may be 1, 8, 32, 64 or any other number according to a specification. The plurality of reference frames enables an encoder to select more than one reference frame on which to base macroblock encoding of a current frame.

Further, during encoding, each video frame may be divided into a number of macroblocks or coding units to be encoded. Often, the macroblock or coding unit is further divided into partitions of various sizes throughout the frame based on the image content. To find an optimal combination and ordering of partitions, a video encoder may use positional data to determine the type of encoding to apply to each macroblock. In embodiments, different reference frames can be selected for encoding different macroblocks in the same frame. For example, in FIG. 1, various portions of reference frames 110H and 110A may be used to encode frame 106.

In another example, a reference frame list may include 16 or 32 reference frames for AVC/HEVC encoding, depending on frame type. As discussed above, the frame type includes, but is not limited to, I-frames, B-frames, and P-frames. When a frame is inter-predicted (I-frame), it points to other frames in the past to copy a particular block of the frame over as a prediction and then coefficients are used to improve the quality of that reference. The more accurate that reference in the past is to the frame being predicted (current frame), the less bits that are used to encode the current frame. This results in a high quality video at a low bitrate.

In embodiments, the HMD 104 includes positional trackers that indicate where a user is looking. Put another way, the positional trackers may be used to determine the direction of a user's gaze or the location of a user's field of view. The positional trackers may also indicate the user's location. In embodiments, the location may be indicated via six degrees of freedom. In particular, the head of a user may be tracked in X, Y, and Z coordinates through movements that occur forward and backwards, side to side, and shoulder to shoulder. In embodiments, the movement of a user may be referred to as pitch, yaw and roll. Conventionally, reference frames are stored with regards to a fixed time pattern (every other frame or every eighth frame) or based on significant changes such as a scene change. However, the present techniques use the tracking information to store or update reference frames. The position and motion information can be used to store reference frames in combination with a fixed time pattern used to update or store reference frames. For example, a reference frame at a particular location may be updated according to a fixed time pattern, such as every other frame or every eighth frame.

FIGS. 2A, 2B, and 2C illustrate reference frames used for encoding based on the position or motion of a user. A user 202 may wear an HMD, such as the HMD 104. For ease of illustration, the HMD is not illustrated in FIGS. 2A, 2B, and 2C. At time t=0 milliseconds (ms), the user 202 looks straight ahead. Thus, the scene rendered for the user 202 corresponds to reference frame 110B as illustrated in FIG. 1. In FIG. 2, arrow 212 illustrates a user 202 head movement to the left. In FIG. 2B, at time t=50 ms, the scene to be rendered for the user 202 overlaps reference frame 110A, which will then be stored for a long term reference.

The most common reference frame is the last frame encoded (the frame that is temporally adjacent). However, some frames are stored for long term reference. If referenceable frames are not specified, then all frames would be stored which would consume a large portion of memory bandwidth and is not practical. Accordingly, video codecs have a list of frames that can be stored for future reference. In FIG. 2B, arrow 214 illustrates the user's 202 next move to the right. In FIG. 2C, the user 202 then moves back toward reference frame 110A at time of t=80 ms, at which point the reference frame 110A is updated.

In an example, the user 202 could have continued moving toward reference frame 110G, which would then have been updated as the user movement caused the scene to include encoding via the reference frame 110G. As the position and motion information is updated, the reference frames can be updated. In embodiments, the position and motion information for a particular reference frame is updated after an ideal amount of overlap or a partial overlap occurs between a current frame and the particular reference frame. If the user changes direction part way through a movement and the past reference frame is non-existent or very old, the reference frame may be updated. The reference list update decision will take into account the time since last updated, the quantization parameter used in the last reference frame, the amount of information changing in the last reference to decide as well as the position to determine if a new reference should be used. In embodiments, a quantization parameter is adjusted based on a direction and type of motion in response to motion by the user.

As discussed above, various video standards may be used according to the present techniques. Exemplary standards include the H.264/MPEG-4 Advanced Video Coding (AVC) standard developed by the ITU-T Video Coding Experts Group (VCEG) with the ISO/IEC JTC1 Moving Picture Experts Group (MPEG), first completed in May 2003 with several revisions and extensions added to date. Another exemplary standard is the High Efficiency Video Coding (HEVC) standard developed by the same organizations with the second version completed and approved in 2014 and published in early 2015. A third exemplary standard is the VP9 standard, initially released on Dec. 13, 2012 by Google.

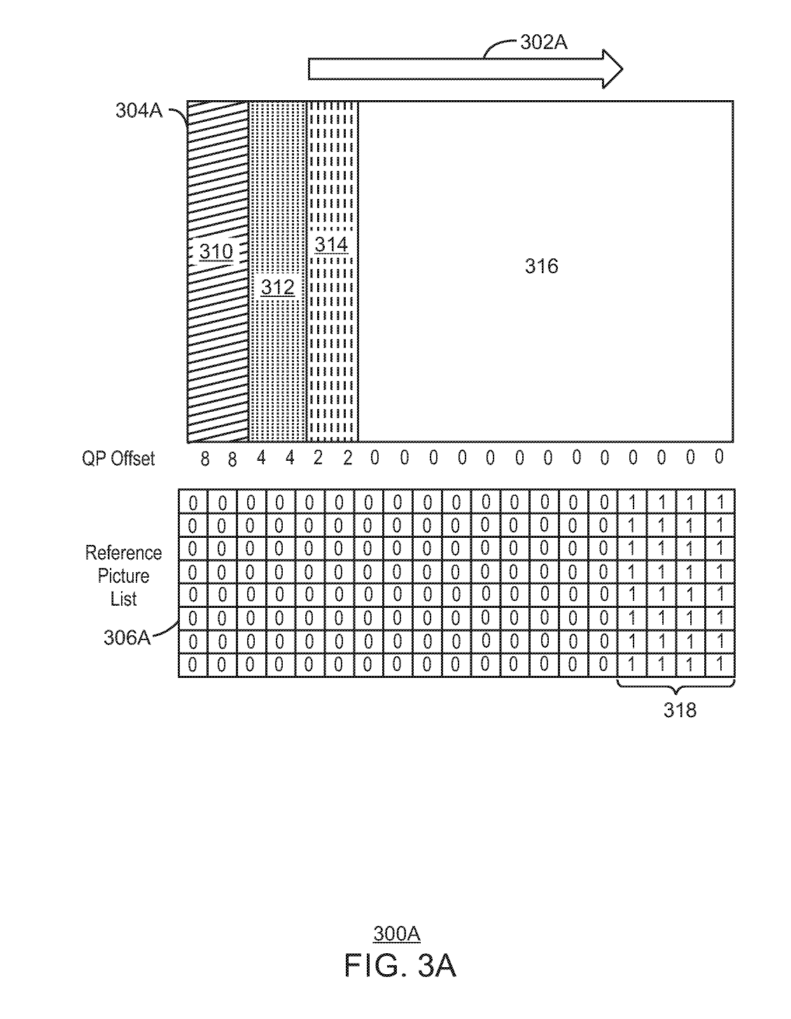

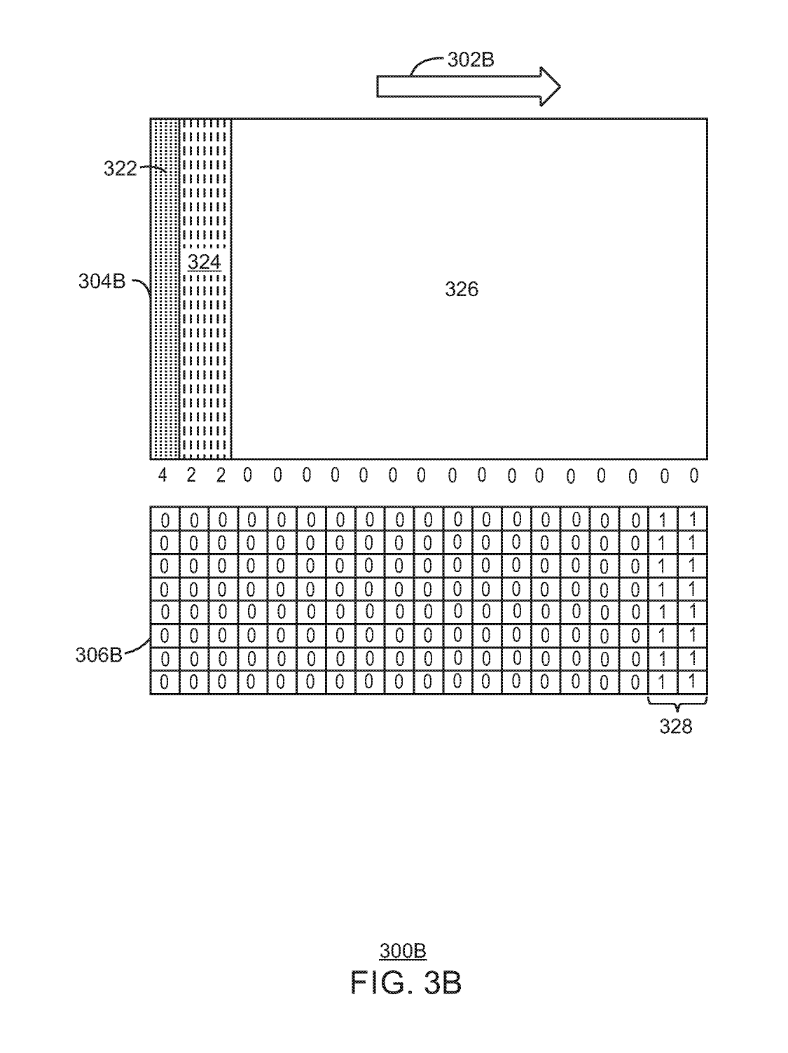

FIGS. 3A and 3B illustrate a frame 300A and a frame 300B encoded via position and motion information. In embodiments, the encoder uses the position and motion information to make encoding decisions. FIG. 3A includes an arrow 302A that indicates a long motion. As used herein, the long motion occurs when a user moves quickly such that the distance objects travelled in the scene from one frame to the next is larger than a predetermined threshold. The predetermined threshold may be, for example, a proportion of the field of view. In particular, if the object moves more than halfway across the field of view, the motion may be considered a long motion. In embodiments, the predetermined threshold may be set by a user to control video encoding quality.

The block 304A represents a QP offset. The block 306A represents the reference picture list, wherein the reference picture list includes a plurality of reference frames. For purposes of description, the reference picture list used in FIGS. 3A and 3B include at least a reference frame 0 and a reference frame 1.

The block 304A includes several different quantization parameters (QPs) 310, 312, 314, and 316. Their respective QP offsets are illustrated along the bottom of block 304A as 8, 4, 2, and 0. The QP 310 with an offset of 8 is larger than the QP 312, QP 314, and QP 316. The QP 312 with an offset of 4 is larger than the QP 314 and QP 316. The QP 314 with an offset of 2 is larger than the QP 316 with an offset of 0. The larger QP uses less bits to encode the frame, but also produces a lower quality image.

In the example of FIG. 3A, when a frame is encoded only part of the reference frame 0 will be shown in the HMD, which will be encoded using the latest positional information on the HMD. Since the user is moving to the right with a long motion as indicated by arrow 302A, it is most likely that the pixels to the left of the screen will not be shown, or if they are shown they will not persist for many frames. Most pixels to the left are encoded using the reference frame 0. Instead of using bits to encode those sections with the highest detail, a higher QP is used to encode less bits on those portions of the scene. In embodiments, the amount of QP offset and the size of the region with the QP offset changes with the rate of motion.

Similarly, FIG. 3B includes an arrow 302B that indicates a short motion. As used herein, the short motion occurs when a user moves slower such that the distance objects travelled in the scene from one frame to the next is smaller than the predetermined threshold. In particular, if the object moves less than halfway across the field of view, the motion may be considered a long motion. The block 304B represents a QP offset, and the block 306B represents the reference picture list similar to FIG. 3A. The block 304B includes several different quantization parameters 322, 324, and 326. Their respective QP offsets are illustrated along the bottom of block 304B as 4, 2, and 0. The QP 322 with an offset of 4 is larger than the QP 324 and QP 326. The QP 324 with an offset of 2 is larger than the QP 326 with an offset of 0. In FIG. 3B, the short motion as indicated by arrow 302B results in less of the reference frame 1 being used for encoding. Put another way, less of frame 1 is used for encoding since the current frame being rendered remains spatially closest to frame 0.

Thus, the reference frame selection to encode the current frame usually uses the closest in time frame or the prior frame. However, with the user moving, some parts of the scene were not shown in the prior frame. Since the reference picture list has been stored with temporal location, the new part of the scene can reference the last picture or frame with that needed temporal information stored (such as reference frame 1 in the reference picture list 306A). This scheme saves encoder performance by not checking multiple references blindly, reduces bandwidth, and also gives improved compression.

The present techniques also enable error recovery where the encoded video is rendered. In embodiments, the encoded video is rendered on the HMD. In particular, on the host device, the temporal location information is known for the frame sent for rendering. This temporal location can be used to enhance error recovery on the HMD in, for example, a wireless VR scenario. The HMD stores reference frames that correspond to temporal location (like what was previously shown). Ideally these reference frames used for error recovery have the objects in motion in the scene that were stored in the frame removed, since the moving objects will likely leave the scene before the reference frame is needed for error recovery. To remove the objects in motion, the motion vector information from the decoder can be used to separate the moving objects from the background. Additionally, a median frame can be used over several frames to remove noise and background objects that might be smaller than the block size used in the particular codec used for encoding. As used herein, a median frame is a frame with pixel values that are the average of a certain number of previous frames. The previous frames may be re-projected to match the same physical location. If a predicted frame does not have the information due to sudden movement or if the frame gets dropped it can be recreated more accurately using the position based stored frames. Thus, error recovery is used to correct errors in frames to be rendered, such a lost information or artifacts.

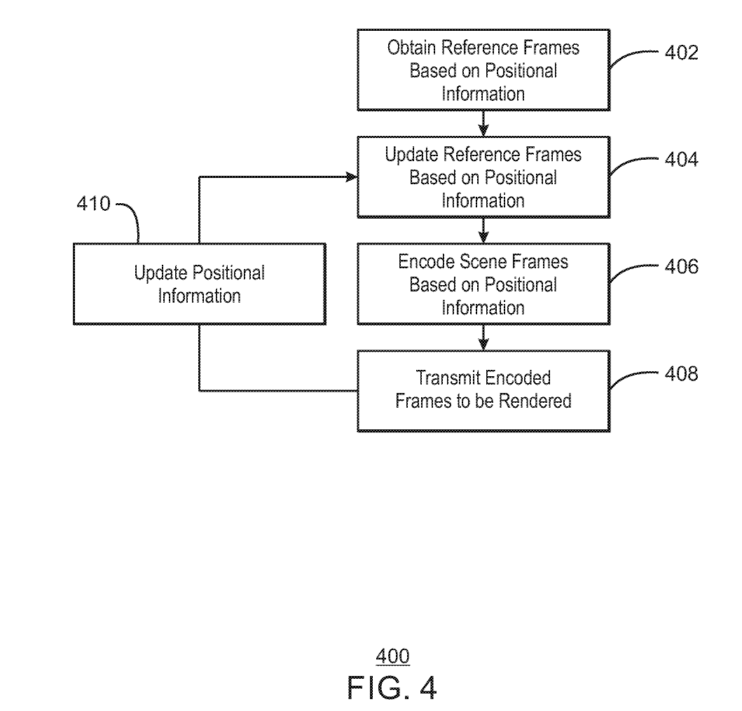

FIG. 4 is a process flow diagram of a method 400 for an IMU enhanced reference list management and encoding. At block 402, a plurality of reference frames are obtained based on positional information of a user. In embodiments, the position information and motion information is obtained from a HMD worn by the user. At block 404, the reference frames are updated based on the position information and motion information of a user. At block 406, frames of the scene are encoded based on the position and motion information. In embodiments, various macroblocks of a frame to be rendered are encoded based on a spatial relationship to a reference frame. For example, a macroblock may be specified using a spatially closest macroblock of a corresponding reference frame. At block 408, the frames are transmitted to a display to be rendered for a user. In embodiments, the display is within a HMD. At block 410, the positional information is updated. In embodiments, both the positional information and the motion information is updated when a user moves beyond a predetermined threshold, or when a rate of movement of a user is above a particular threshold.

Other conventional wireless solutions such as video conference or wireless display uses reference frame picture management based on fixed patterns and checking for changes in content (scene changes). Using the position tracking information according to the present techniques, the reference frames can be stored based on the location being viewed. As a user scans back to another section of the screen that was previously viewed, a reference frame of that prior scene that was viewed earlier can be used which improves the frame compression. In some cases, wireless VR compression suffers most as the viewer changes head position. With a quick head position change, a low bitrate can be maintained without hurting quality (quality can drop more than 5 dB under head motion). In embodiments, the reference frame can be selected based on the position instead of checking frames known to be poor predictors. This can result in a two times or greater performance reduction compared to other multi reference implementations (checking all possible references or using some heuristics like checking other references if the distortion is over some threshold).

Moreover, error recovery typically replicates pixels on the edge of a frame or copies information from a previous frame. This results in an obvious tear artifact. By using the positional tracking information in error recovery, tears for the background can be avoided thus giving a much better visual experience for the user. Further, QP adjustment is typically based on content by using a higher or lower QP for parts that are more complicated or that have changed frame to frame. Modifying the QP field according to the motion as described herein enables bits soon to be leaving the frame to be saved and allocated toward content soon entering the frame. Put another way, content entering the frame may be a higher QP than content leaving the frame, where content entering and leaving the frame is based on the positional and motion information. The overall bitrate impact depends on the speed of the motion and the details in the content.

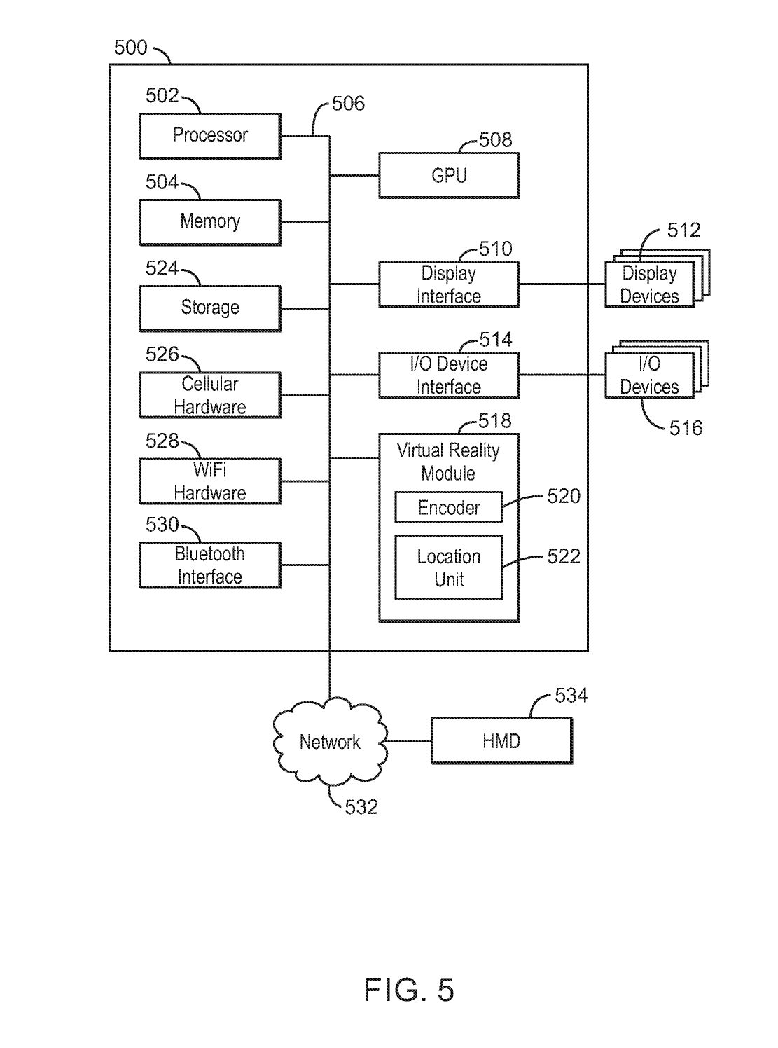

FIG. 5 is a block diagram of an exemplary system that enables IMU enhanced reference list management and encoding. The electronic device 500 may be, for example, a laptop computer, tablet computer, mobile phone, smart phone, or a wearable device, among others. The electronic device 500 may be used to receive and render media such as images and videos. The electronic device 500 may include a central processing unit (CPU) 502 that is configured to execute stored instructions, as well as a memory device 504 that stores instructions that are executable by the CPU 502. The CPU may be coupled to the memory device 504 by a bus 506. Additionally, the CPU 502 can be a single core processor, a multi-core processor, a computing cluster, or any number of other configurations. Furthermore, the electronic device 500 may include more than one CPU 502. The memory device 504 can include random access memory (RAM), read only memory (ROM), flash memory, or any other suitable memory systems. For example, the memory device 504 may include dynamic random access memory (DRAM).

The electronic device 500 also includes a graphics processing unit (GPU) 508. As shown, the CPU 502 can be coupled through the bus 506 to the GPU 508. The GPU 508 can be configured to perform any number of graphics operations within the electronic device 500. For example, the GPU 508 can be configured to render or manipulate graphics images, graphics frames, videos, streaming data, or the like, to be rendered or displayed to a user of the electronic device 500. In some embodiments, the GPU 508 includes a number of graphics engines, wherein each graphics engine is configured to perform specific graphics tasks, or to execute specific types of workloads.

The CPU 502 can be linked through the bus 506 to a display interface 510 configured to connect the electronic device 500 to one or more display devices 512. The display devices 512 can include a display screen that is a built-in component of the electronic device 500. In embodiments, the display interface 510 is coupled with the display devices 512 via any networking technology such as cellular hardware 524, Wi-Fi hardware 526, or Bluetooth Interface 528 across the network 532. The display devices 512 can also include a computer monitor, television, or projector, among others, that is externally connected to the electronic device 500.

The CPU 502 can also be connected through the bus 506 to an input/output (I/O) device interface 514 configured to connect the electronic device 500 to one or more I/O devices 516. The I/O devices 516 can include, for example, a keyboard and a pointing device, wherein the pointing device can include a touchpad or a touchscreen, among others. The I/O devices 516 can be built-in components of the electronic device 500, or can be devices that are externally connected to the electronic device 500. Accordingly, in embodiments, the I/O device interface 514 is coupled with the I/O devices 516 via any networking technology such as cellular hardware 524, Wi-Fi hardware 526, or Bluetooth Interface 528 across the network 532. The I/O devices 516 can also include any I/O device that is externally connected to the electronic device 500.

A virtual reality module 518 may be used to encode video data. The video data may be stored to a file or rendered on a display device. In particular, the display device may be a component of an HMD 534. In embodiments, the electronic device 500 executes a game that is displayed on the HMD 534. In such an example, the electronic device 500 communicates with the HMD 534 to display images in the course of game play. The execution of gaming tasks may be done on the electronic device 500, on the HMD 534, or on any combination of both the electronic device 500 and HMD 534. The electronic device 500 may also enable a virtual environment that is displayed on an HMD 534. In such an example, the electronic device 500 communicates with the HMD 502 to display images in the movement through the virtual environment. In embodiments, the virtual environment may integrate objects from the real world environment. The rendering of the virtual environment, real world environment, or any combination thereof may be done on the electronic device 500, on the HMD 534, or on any combination of both the electronic device 500 and HMD 534. Further, the HMD may include a location unit, receiver and a display. The location unit may update the reference frames and the receiver may receive encoded frames of a scene, wherein the frames re encoded based on the reference frames and the position and motion information.

The virtual reality module 518 may include an encoder 520 and a temporal/spatial location unit 522. The encoder 520 is to encode video data or a video stream by at least generating a bit stream from the video data that complies with the requirements of a particular standard. Generating the encoded bit stream includes making mode decisions for each a block. As used herein, a block or portion is a sequence of pixels horizontally and vertically sampled. The block, portion, or partition may also refer to the coding unit or macroblock used during encoding. The mode refers to a type of compression applied to each block, such as an intra-prediction, inter-prediction, and the like.

In particular, video encoding involves dividing a frame into smaller blocks (coding units or macroblocks). Each of those blocks can be divided into different sizes and have different modes. Typically, an encoder will process each block with the same operations and the encoding begins with the largest block (e.g. 2N×2N or 64×64 for HEVC) and continues until it has processed the smallest block size. Changing the block size is done to improve the compression efficiency by using different modes or motion vectors for the smaller blocks instead of a larger block with one mode and/or motion vector. The tradeoff when changing the block size is the quality of the resulting bit stream and the size of the bit stream relative to the quality.

The temporal/spatial location unit 522 obtains positional information to optimize the encoding process. Positional information may include both position and location information. The temporal/spatial location unit 522 may initially determine the position and motion of a user, then use that information to determine dependencies between the current frame and the reference frames used during encoding. As used herein, dependencies refer to the relationship between spatially adjacent coding units to derive predicted motion vectors (or merge candidates) as well as intra most probable modes. For example, algorithms for compressing frames differ by the amount of data provided to specify the image contained within the frame. For example, the frames may be specified during compression using intra-coded frames (I-frames), predicted picture frames (P-frames) and bi-directional predicted picture frames (B-frames). As used herein, specified refers to the data that is saved for each frame during compression. An I-frame is fully specified. A P-frame is specified by saving the changes that occur in each frame when compared to the previous frame, while a B-frame is specified by saving the changes that occur in each frame when compared to both the previous frame and the following frame. Thus, P- and B-frames have dependencies on other frames. The present techniques enable adaptive dependencies based on position and location information.

The electronic device 500 may also include a storage device 524. The storage device 524 is a physical memory such as a hard drive, an optical drive, a flash drive, an array of drives, or any combinations thereof. The storage device 524 can store user data, such as audio files, video files, audio/video files, and picture files, among others. The storage device 524 can also store programming code such as device drivers, software applications, operating systems, and the like. The programming code stored to the storage device 524 may be executed by the CPU 502, GPU 508, or any other processors that may be included in the electronic device 500.

The CPU 502 may be linked through the bus 506 to cellular hardware 526. The cellular hardware 526 may be any cellular technology, for example, the 4G standard (International Mobile Telecommunications-Advanced (IMT-Advanced) Standard promulgated by the International Telecommunications Union—Radio communication Sector (ITU-R)). In this manner, the electronic device 500 may access any network 532 without being tethered or paired to another device, where the cellular hardware 526 enables access to the network 532.

The CPU 502 may also be linked through the bus 506 to Wi-Fi hardware 528. The Wi-Fi hardware 528 is hardware according to Wi-Fi standards (standards promulgated as Institute of Electrical and Electronics Engineers' (IEEE) 802.11 standards). The Wi-Fi hardware 528 enables the electronic device 500 to connect to the Internet using the Transmission Control Protocol and the Internet Protocol (TCP/IP). Accordingly, the electronic device 500 can enable end-to-end connectivity with the Internet by addressing, routing, transmitting, and receiving data according to the TCP/IP protocol without the use of another device. Additionally, a Bluetooth Interface 530 may be coupled to the CPU 502 through the bus 506. The Bluetooth Interface 530 is an interface according to Bluetooth networks (based on the Bluetooth standard promulgated by the Bluetooth Special Interest Group). The Bluetooth Interface 530 enables the electronic device 500 to be paired with other Bluetooth enabled devices through a personal area network (PAN). Accordingly, the network 532 may be a PAN. Examples of Bluetooth enabled devices include a laptop computer, desktop computer, ultrabook, tablet computer, mobile device, or server, among others.

The block diagram of FIG. 5 is not intended to indicate that the electronic device 500 is to include all of the components shown in FIG. 5. Rather, the computing system 500 can include fewer or additional components not illustrated in FIG. 5 (e.g., sensors, power management integrated circuits, additional network interfaces, etc.). The electronic device 500 may include any number of additional components not shown in FIG. 5, depending on the details of the specific implementation. Furthermore, any of the functionalities of the CPU 502 may be partially, or entirely, implemented in hardware and/or in a processor. For example, the functionality may be implemented with an application specific integrated circuit, in logic implemented in a processor, in logic implemented in a specialized graphics processing unit, or in any other device.

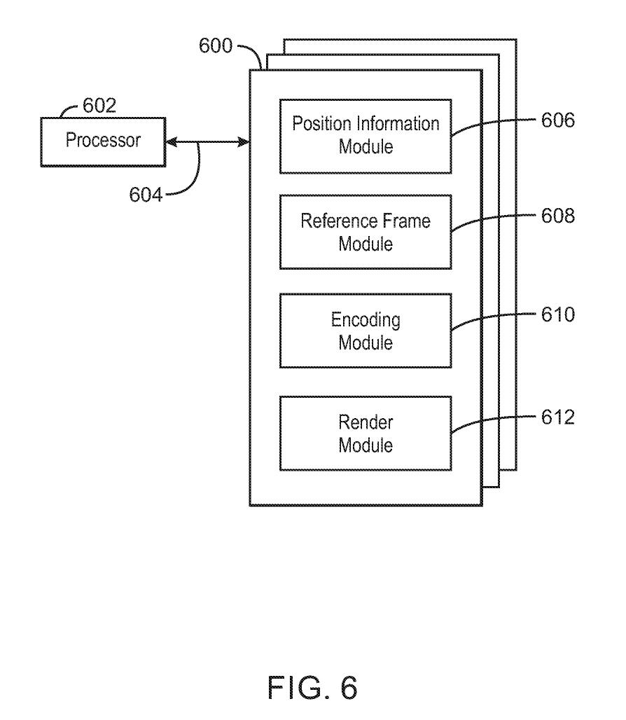

FIG. 6 is a block diagram showing a medium 600 that contains logic for an IMU enhanced reference list management and encoding. The medium 600 may be a computer-readable medium, including a non-transitory medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The various software components discussed herein may be stored on the tangible, non-transitory computer-readable medium 600, as indicated in FIG. 6. The medium 600 may include modules 606-612 configured to perform the techniques described herein. For example, a position information module 606 may be configured to obtain or update position information. In embodiments, a motion information module may be used to obtain or update motion information. A reference frame module 608 may be configured to determine a plurality of reference frames based on position information. An encoding module 610 may be configured to encode frames based on at least positional information and the reference frames. Further, a render module 612 may be configured to render the encoded video stream. Rendering the encoded video stream may include decoding the video stream. The video stream may also be transmitted to another device before it is rendered.

The block diagram of FIG. 6 is not intended to indicate that the tangible, non-transitory computer-readable medium 600 is to include all of the components shown in FIG. 6. Further, the tangible, non-transitory computer-readable medium 600 may include any number of additional components not shown in FIG. 6, depending on the details of the specific implementation.

Example 1 is a method. The method includes obtaining a plurality of reference frames; updating the plurality of reference frames based on a position information and a motion information of a user; encoding a current frame of a scene based on the plurality of reference frames and a spatial location of the current frame; and transmitting the current frame after encoding to be rendered.

Example 2 includes the method of example 1, including or excluding optional features. In this example, the plurality of reference frames are updated when the position information or motion information changes greater than a predetermined threshold.

Example 3 includes the method of any one of examples 1 to 2, including or excluding optional features. In this example, the current frame is encoded based on a reference frame that is the closest to the current frame.

Example 4 includes the method of any one of examples 1 to 3, including or excluding optional features. In this example, the current frame after encoding is transmitted wirelessly to a head mounted display to be rendered.

Example 5 includes the method of any one of examples 1 to 4, including or excluding optional features. In this example, the current frame is encoded via a macroblock referencing a reference frame of the plurality of reference frames that is spatially the closest relative to the user position to the macroblock.

Example 6 includes the method of any one of examples 1 to 5, including or excluding optional features. In this example, the current frame is encoded via multiple reference frames of the plurality of reference frames.

Example 7 includes the method of any one of examples 1 to 6, including or excluding optional features. In this example, the plurality of reference frames are stored at a head mounted display, and the head mounted display enables error recovery based on a position information and a motion information associated with the plurality of reference frames.

Example 8 includes the method of any one of examples 1 to 7, including or excluding optional features. In this example, a head mounted display enables error recovery based on a median frame.

Example 9 includes the method of any one of examples 1 to 8, including or excluding optional features. In this example, the plurality of reference frames are inter-predicted frames.

Example 10 includes the method of any one of examples 1 to 9, including or excluding optional features. In this example, in response to motion by the user, a quantization parameter is adjusted based on a direction and type of user motion.

Example 11 is an apparatus. The apparatus includes a head mounted display to obtain a plurality of reference frames; a location unit to update the plurality of reference frames based on a position information of a user; a receiver to receive encoded frames of a scene, wherein the encoded frames are encoded based on the plurality of reference frames and a spatial location of each encoded frame; and a display to render the encoded frames.

Example 12 includes the apparatus of example 11, including or excluding optional features. In this example, the position information of the user is obtained from an inertial measurement unit (IMU) of the head mounted display.

Example 13 includes the apparatus of any one of examples 11 to 12, including or excluding optional features. In this example, the position information of the user is obtained from a position tracker of the head mounted display.

Example 14 includes the apparatus of any one of examples 11 to 13, including or excluding optional features. In this example, the receiver enables error recovery based on the position and motion information associated with the plurality of reference frames.

Example 15 includes the apparatus of any one of examples 11 to 14, including or excluding optional features. In this example, the receiver enables error recovery based on a median frame.

Example 16 includes the apparatus of any one of examples 11 to 15, including or excluding optional features. In this example, the position information and the reference frames are updated when a position of the user changes above a predetermined threshold.

Example 17 includes the apparatus of any one of examples 11 to 16, including or excluding optional features. In this example, temporal information associated with the plurality of reference frames is stored for use in error recovery. Optionally, objects in motion in the plurality of reference frames are removed prior to error recovery.

Example 18 includes the apparatus of any one of examples 11 to 17, including or excluding optional features. In this example, the encoded frames are encoded via a macroblock referencing a reference frame of the plurality of reference frames that is spatially the closest relative to the user position to the macroblock.

Example 19 includes the apparatus of any one of examples 11 to 18, including or excluding optional features. In this example, the encoded frames are rendered in combination with a real world environment.

Example 20 is a system. The system includes a display to render a plurality of frames; a memory that is to store instructions and that is communicatively coupled to the display; and a processor communicatively coupled to the display and the memory, wherein when the processor is to execute the instructions, the processor is to: obtain a plurality of reference frames; update the plurality of reference frames based on a position information and a motion information of a user; encode a current frame of a scene based on the plurality of reference frames and a spatial location of the current frame; and transmit the current frame after encoding to be rendered

Example 21 includes the system of example 20, including or excluding optional features. In this example, the plurality of reference frames are updated when the position information or motion information changes greater than a predetermined threshold.

Example 22 includes the system of any one of examples 20 to 21, including or excluding optional features. In this example, the current frame is encoded based on a reference frame that is the closest to the current frame.

Example 23 includes the system of any one of examples 20 to 22, including or excluding optional features. In this example, the current frame after encoding is transmitted wirelessly to a head mounted display to be rendered.

Example 24 includes the system of any one of examples 20 to 23, including or excluding optional features. In this example, the current frame is encoded via a macroblock referencing a reference frame of the plurality of reference frames that is spatially the closest relative to the user position to the macroblock.

Example 25 includes the system of any one of examples 20 to 24, including or excluding optional features. In this example, the current frame is encoded via multiple reference frames of the plurality of reference frames.

Example 26 includes the system of any one of examples 20 to 25, including or excluding optional features. In this example, the plurality of reference frames are stored at a head mounted display, and the head mounted display enables error recovery based on a position information and a motion information associated with the plurality of reference frames.

Example 27 includes the system of any one of examples 20 to 26, including or excluding optional features. In this example, a head mounted display enables error recovery based on a median frame.

Example 28 includes the system of any one of examples 20 to 27, including or excluding optional features. In this example, the plurality of reference frames are inter-predicted frames.

Example 29 includes the system of any one of examples 20 to 28, including or excluding optional features. In this example, in response to motion by the user, a quantization parameter is adjusted based on a direction and type of user motion.

Example 30 is a tangible, non-transitory, computer-readable medium. The computer-readable medium includes instructions that direct the processor to obtaining a plurality of reference frames; updating the plurality of reference frames based on a position information and a motion information of a user; encoding a current frame of a scene based on the plurality of reference frames and a spatial location of the current frame; and transmitting the current frame after encoding to be rendered.

Example 31 includes the computer-readable medium of example 30, including or excluding optional features. In this example, the plurality of reference frames are updated when the position information or motion information changes greater than a predetermined threshold.

Example 32 includes the computer-readable medium of any one of examples 30 to 31, including or excluding optional features. In this example, the current frame is encoded based on a reference frame that is the closest to the current frame.

Example 33 includes the computer-readable medium of any one of examples 30 to 32, including or excluding optional features. In this example, the current frame after encoding is transmitted wirelessly to a head mounted display to be rendered.

Example 34 includes the computer-readable medium of any one of examples 30 to 33, including or excluding optional features. In this example, the current frame is encoded via a macroblock referencing a reference frame of the plurality of reference frames that is spatially the closest relative to the user position to the macroblock.

Example 35 includes the computer-readable medium of any one of examples 30 to 34, including or excluding optional features. In this example, the current frame is encoded via multiple reference frames of the plurality of reference frames.

Example 36 includes the computer-readable medium of any one of examples 30 to 35, including or excluding optional features. In this example, the plurality of reference frames are stored at a head mounted display, and the head mounted display enables error recovery based on a position information and a motion information associated with the plurality of reference frames.

Example 37 includes the computer-readable medium of any one of examples 30 to 36, including or excluding optional features. In this example, a head mounted display enables error recovery based on a median frame.

Example 38 includes the computer-readable medium of any one of examples 30 to 37, including or excluding optional features. In this example, the plurality of reference frames are inter-predicted frames.

Example 39 includes the computer-readable medium of any one of examples 30 to 38, including or excluding optional features. In this example, in response to motion by the user, a quantization parameter is adjusted based on a direction and type of user motion.

Example 40 is an apparatus. The apparatus includes instructions that direct the processor to a head mounted display to obtain a plurality of reference frames; a means to update the plurality of reference frames based on a position information of a user; a receiver to receive encoded frames of a scene, wherein the encoded frames are encoded based on the plurality of reference frames and a spatial location of each encoded frame; and a display to render the encoded frames.

Example 41 includes the apparatus of example 40, including or excluding optional features. In this example, the position information of the user is obtained from an inertial measurement unit (IMU) of the head mounted display.

Example 42 includes the apparatus of any one of examples 40 to 41, including or excluding optional features. In this example, the position information of the user is obtained from a position tracker of the head mounted display.

Example 43 includes the apparatus of any one of examples 40 to 42, including or excluding optional features. In this example, the receiver enables error recovery based on the position and motion information associated with the plurality of reference frames.

Example 44 includes the apparatus of any one of examples 40 to 43, including or excluding optional features. In this example, the receiver enables error recovery based on a median frame.

Example 45 includes the apparatus of any one of examples 40 to 44, including or excluding optional features. In this example, the position information and the reference frames are updated when a position of the user changes above a predetermined threshold.

Example 46 includes the apparatus of any one of examples 40 to 45, including or excluding optional features. In this example, temporal information associated with the plurality of reference frames is stored for use in error recovery. Optionally, objects in motion in the plurality of reference frames are removed prior to error recovery.

Example 47 includes the apparatus of any one of examples 40 to 46, including or excluding optional features. In this example, the encoded frames are encoded via a macroblock referencing a reference frame of the plurality of reference frames that is spatially the closest relative to the user position to the macroblock.

Example 48 includes the apparatus of any one of examples 40 to 47, including or excluding optional features. In this example, the encoded frames are rendered in combination with a real world environment.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method, comprising:
obtaining a plurality of reference frames;
updating the plurality of reference frames based on a position information and a motion information of a user;
encoding a current frame of a scene based on the plurality of reference frames and a spatial location of the current frame; and
transmitting the current frame after encoding to be rendered.

2. The method of claim 1, wherein the plurality of reference frames are updated when the position information or motion information changes greater than a predetermined threshold.

3. The method of claim 1, wherein the current frame is encoded based on a reference frame that is the closest to the current frame.

4. The method of claim 1, wherein the current frame after encoding is transmitted wirelessly to a head mounted display to be rendered.

5. The method of claim 1, wherein the current frame is encoded via a macroblock referencing a reference frame of the plurality of reference frames that is spatially the closest relative to the user position to the macroblock.

6. The method of claim 1, wherein the current frame is encoded via multiple reference frames of the plurality of reference frames.

7. The method of claim 1, wherein the plurality of reference frames are stored at a head mounted display, and the head mounted display enables error recovery based on a position information and a motion information associated with the plurality of reference frames.

8. The method of claim 1, wherein a head mounted display enables error recovery based on a median frame.

9. The method of claim 1, wherein the plurality of reference frames are inter-predicted frames.

10. The method of claim 1, wherein in response to motion by the user, a quantization parameter is adjusted based on a direction and type of user motion.

11. An apparatus, comprising:
a head mounted display to obtain a plurality of reference frames;
a location unit to update the plurality of reference frames based on a position information of a user;
a receiver to receive encoded frames of a scene, wherein the encoded frames are encoded based on the plurality of reference frames and a spatial location of each encoded frame; and
a display to render the encoded frames.

12. The apparatus of claim 11, wherein the position information of the user is obtained from an inertial measurement unit (IMU) of the head mounted display.

13. The apparatus of claim 11, wherein the position information of the user is obtained from a position tracker of the head mounted display.

14. The apparatus of claim 11, wherein the receiver enables error recovery based on the position and motion information associated with the plurality of reference frames.

15. The apparatus of claim 11, wherein the receiver enables error recovery based on a median frame.

16. The apparatus of claim 11, wherein the position information and the reference frames are updated when a position of the user changes above a predetermined threshold.

17. A system, comprising:
a display to render a plurality of frames;
a memory that is to store instructions and that is communicatively coupled to the display; and
a processor communicatively coupled to the display and the memory, wherein when the processor is to execute the instructions, the processor is to:
obtain a plurality of reference frames;
update the plurality of reference frames based on a position information and a motion information of a user;
encode a current frame of a scene based on the plurality of reference frames and a spatial location of the current frame; and
transmit the current frame after encoding to be rendered.

18. The system of claim 17, wherein the plurality of reference frames are updated when the position information or motion information changes greater than a predetermined threshold.

19. The system of claim 17, wherein the current frame is encoded based on a reference frame that is the closest to the current frame.

20. The system of claim 17, wherein the current frame after encoding is transmitted wirelessly to a head mounted display to be rendered.

21. The system of claim 17, wherein the current frame is encoded via a macroblock referencing a reference frame of the plurality of reference frames that is spatially the closest relative to the user position to the macroblock.

22. The system of claim 17, wherein the current frame is encoded via multiple reference frames of the plurality of reference frames.

23. The system of claim 17, wherein the plurality of reference frames are stored at a head mounted display, and the head mounted display enables error recovery based on a position information and a motion information associated with the plurality of reference frames.

24. The system of claim 17, wherein a head mounted display enables error recovery based on a median frame.

25. The system of claim 17, wherein the plurality of reference frames are inter-predicted frames.
